(19) United States
(12) Patent Application Publication
(10) Pub. No.: US 2019/0291701 A1
(43) Pub. Date: Sep. 26, 2019

(54) FUEL DISTRIBUTION STATION FOR SELF-CONSUMPTION

(71) Applicant: SERVICIOS INDUSTRIALES DASI SA DE CV, CADEREYTA (MX)

(72) Inventor: DANIEL GERARDO DAVILA SILVA, CADEREYTA (MX)

(73) Assignee: SERVICIOS INDUSTRIALES DASI SA DE CV, CADEREYTA (MX)

(21) Appl. No.: 16/359,752

(22) Filed: Mar. 20, 2019

(30) Foreign Application Priority Data
Mar. 26, 2018 (MX) MX/U/2018/000166

(51) Int. Cl. B60S 5/02; B67D 7/04; B67D 7/78

(52) U.S. Cl. CPC B60S 5/02; B67D 7/78; B67D 7/04

(57) ABSTRACT

A fuel distribution station for self-consumption that is transportable and that comprises a metal dam for containment of spills formed by a lower load frame, on which a floor and reinforcing perimeter walls reinforced with a reinforcement structure are mounted; inside the containment walls there is a fuel storage tank, which in the lower part has supports and in the upper part presents at least one of each following element: service nozzle, cleaning nozzle, access ladder, lifting and venting lugs; it also incorporates a fuel delivery cabin, also mounted on the lower frame, which includes curtain with pulse mechanism and fittings for padlock and inside it has at least one pump dispenser for the supply of fuel; for its operation also requires carbon steel pipes, accessories such as elbows, nipples, reductions, nuts, unions, flexible hose, full shut-off valves; check valves, filter holder and cartridge type filter, connections for the fuel supply of the pipe, “Y” type filters; as well as level indicator type peephole of polycarbonate tube and its set of valves.

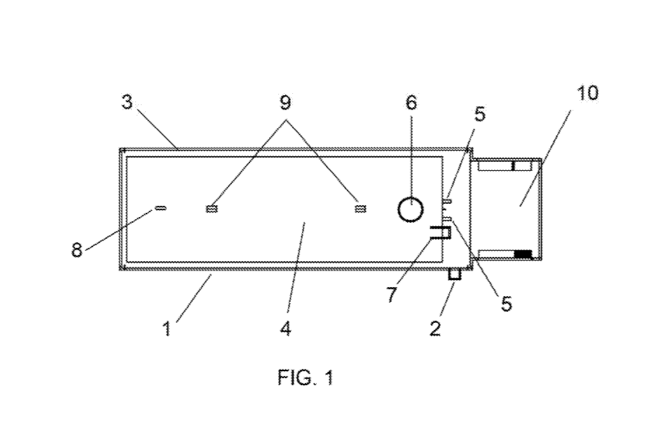

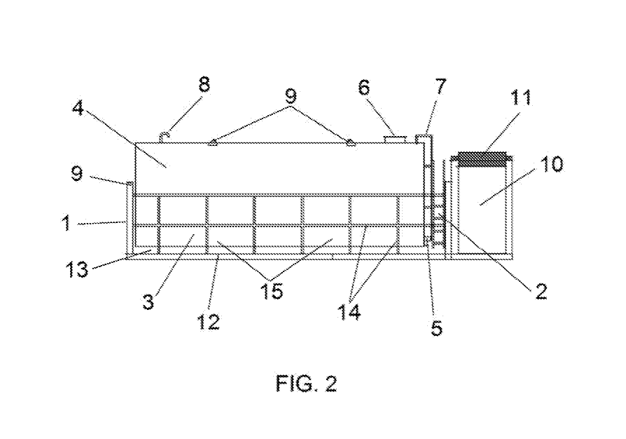

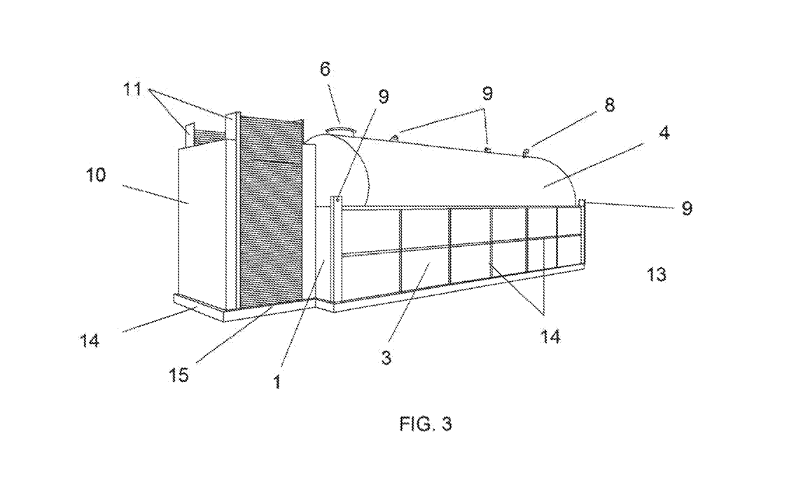

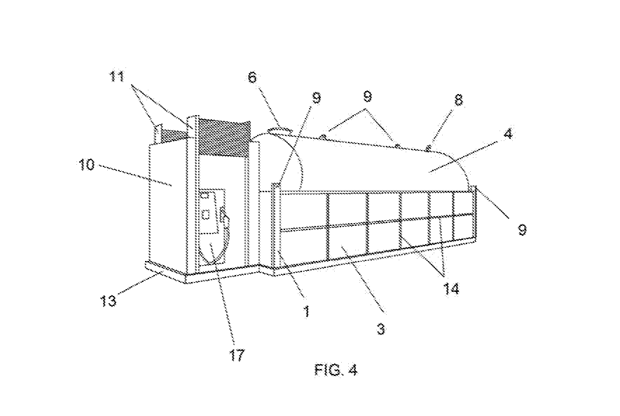

### CROSS-REFERENCE TO RELATED APPLICATIONS

The present application claims priority from Mexico patent Application No. MX/u/2018/000166 filed on Mar. 26, 2018, the entire contents of which are incorporated herein by reference.

### INVENTION FIELD

The present invention is related to fuel distribution stations in general, specifically it is related to a transportable fuel distribution station and more so to a fuel distribution station for self-consumption designed to be transported, comprising a storage tank, spill containment dam, and fuel dispatch booth with at least one security door.

### INVENTION RECITALS

Currently, the fossil fuel distribution is carried out through permanent establishments that require public works, excavations, etc., and that they do not have flexibility in terms of design or configuration.

Automotive fuels are typically stored in underground tanks from which the fuel is pumped to a fuel dispenser for supply in a vehicle. These tanks are usually built of metal or fiberglass. The underground installation of these tanks requires relatively large excavations and their coverage generates many potential problems.

The known fossil fuel distribution stations have very high operating costs, because the stored fuel must be mechanically pumped from the tank to a vehicle and this mechanical pumping consumes a lot of electricity.

In addition to the above, known service stations are of a relatively permanent nature; consequently, in the event that the service station is no longer operating, it must compete with a long and expensive process of removal of everything that was previously built. In many cases, once installed, such facilities cannot be moved to virtually different places nor sold.

In remote areas where fuel distribution service is required, it is not operational to establish service stations referred to above.

In addition to the above, many of the fuel distribution stations regularly present inconveniences for users: delay in waiting time, poor service, insecurity, theft, environmental risks, among others.

Based on the foregoing, the present invention arises from the need for self-consumption fuel stations that ensure the distribution of fuel in the users' facilities, which are transportable, easily operable, that reduce environmental risks and reduce costs in the establishment of stations.

At present, some commercial models of transportable stations for fuel consumption have been presented; all of them conformed by at least one fuel storage tank and at least one fuel dispatch booth and that comply with the corresponding regulations in terms of risk management and safety.

Among the commercial models of stations for self-consumption of fuel we find those that fulfill the same function as the present invention but that present relevant difference in structural design, construction materials, fuel dispatch system operation, fuel assurance, among others.

In some self-consumption station models, the design includes a storage tank without spill containment dam and an exposed dispatch booth; they have a double wall, one of which is of some fiber or coating with reinforcement function;

Other models of self-consumption fuel station do not have reinforcement structure, nor fuel dispatch cabin; even other commercial models of self-consumption station externally have a concrete containment dam without a fuel delivery booth.

These models have the disadvantage that in none of the cases it is possible to prevent and ensure access to the fuel dispensing pump, as well as the extraction thereof; another disadvantage of the aforementioned commercial models is that they do not have an adequate spill containment dam and in some cases they have the disadvantage that if the customer requires to move their facilities to another place for different reasons and it is necessary to take the tank, they will have to build a containment dam where they want to put the tank again, as well as being more difficult to transport.

In order to solve the aforementioned problem, that is, ensure the supply of fuel in the facilities of users while having a self-consumption station designed to be easily transportable, the present invention has a containment dam for avoid fuel spillage risks, a dispatch cabin that allows to restrict and ensure access to the fuel supply through padlocks or other assurance means; also that so the service can incorporate some of the different technologies present in the fuel dispensing pumps, depending on the needs of the client.

A search was made to define the state of the closest technique; as regards to the present invention, the patent was found with application number MX/a120131014947, with a filing date of Dec. 17, 2013, “Mobile fuel distribution station”, by José Cajica, et al.; which states “an environmentally friendly and modular mobile fuel distribution station which includes fuel tank, a support structure having a multiple legs for supporting an operating platform in an elevated position at a predetermined distance above the ground, an alternate power generation device, the alternating power generation device being one of a solar power generator and a wind power generator to provide primary energy to the mobile fuel distribution station and a central platform operatively connected to at least two of the legs, at least two of the legs supporting the central platform weight, where the fuel tank and alternative power generating device are placed on the operating platform”.

The patent with application number US036176, with the date of presentation in Mexico of Mar. 17, 1994, “Fuel distribution system without losses of the same for motor vehicles powered by natural gas”, by MINNESOTA VALLEY ENGINEERING, INC. was also found; disclosing “a fuel distribution station, without loss thereof, for the distribution of liquid natural gas (LNG) to a motor vehicle, which has a tank mounted thereon, where the station is characterized by comprising: a) at least a fuel conditioning tank; b) means for feeding an amount of LNG to at least one fuel conditioning tank; c) means for pressurizing the LNG in at least this single fuel conditioning tank, which includes means for creating and storing compressed natural gas, and distributing the compressed natural gas to the at least one fuel conditioning tank, to obtain a minimum desired pressure to sub-cool, therefore, the LNG for efficient distribution to the mounted tank of the vehicle; and d) means to distribute LNG from at least one fuel conditioning tank to the mounted vehicle tank.”

In the same way, the patent was found with application number CZ20160420, with a filing date of Jul. 11, 2016, “A modular petrol station for vehicles”, under the title of Burian Petr; which states “a modular service station for vehicles with a completely unattended mode, while assistance and mode of payment of the customer are handled through a payment in the terminal, which is part of the fuel dispenser. The modular service station consists of at least one fuel dispenser, is arranged in the concrete shelter of the fiber-reinforced concrete base of the transportable module with the fuel dispenser that is provided with the dividing wall to separate the oily substances separator system from the interceptor emergency sump. The cover of the reinforced concrete base of the transportable module with the fuel dispenser carries the supporting structure of the transportable module with the support structure of the roof and is provided with the distribution technological system of the pumped fuel and the connection axis of the fuel distribution system connected to at least one fuel storage tank of the transportable module with a fuel tank.”

The patent with application number R0123191, with a filing date of Feb. 2, 2012, “Fully automated transportable fuel distribution station”, under the title of Eko Gãze Sia, at al was also found; which states “a transportable station for fuel distribution, such as diesel and/or gasoline, which can operate within a network of distribution stations, monitored and operated from a central dispatcher. According to the invention, within the container-type unit of the claimed station, a compartment of a fuel tank, technical compartment, and distribution pump compartment, all supply connections are provided and separated by some fitted partition walls, as well as the vapor recovery connections of the fuel tank grouped in a fuel discharge outlet located in a side wall of the container-type unit, in a cut made therein that is sealed in relation to the interior space of the container, tank compartment, and provided with an externally controlled access door communication through some pipes to some respective connections of some compartments of the fuel tank placed in the upper part, inside the steam space, the supply connections continue inside the container by a plunger that, in the above maximum liquid level, it has one or more ventilation holes provided with a baffle or a bypass with a unidirectional valve, the other connections of each compartment are grouped in the upper part of the fuel tank, to allow controlled external access to it by one or more manholes provided with some externally controlled access covers.”

The following files related to the present invention were also found: US2005103400, US2004163731, U.S. Pat. No. 6,311,873, LV14447, JP2010181030, FR2761676, FR2798053, FR2674415, AU199897236. NL9401725.

As is evident, the aforementioned documents present novelties concerning modes of fuel self-consumption station different from the present invention, most of them have the disadvantage of not being easily transportable, some are mounted on a support structure for the purpose of saving energy in fuel pumping, energy that is used for the pumping of fuel to the upper reservoirs; another model includes structures built-on concrete that are inadequate in terms of mobility.

In the previous documents none presented a fuel supply station consisting of a storage tank, spill containment dam, and a fuel dispatch cabin with one or two security doors; that in addition to its design contemplate the fact that it is easily transportable, for this, the present invention has the advantage that the structure is mounted on a load frame or reinforcement chassis, also has walls and heavy gauge plate floor reinforced with a rectangular profile and also with upper and lateral lifting lugs; allowing as a whole a rigid structure that supports the load inside and that has the mechanism to be hoisted and transportable on a truck tract.

### INVENTION OBJECTIVES

The main purpose of the present invention is to make available a fuel distribution station for self-consumption that solves the drawbacks presented by the models prior to the present invention.

Another objective of the present invention is that said fuel distribution station for self-consumption can be easily and quickly installed in a minimum space.

Another objective of the present invention is that said fuel distribution station for self-consumption allows fuel storage and dispatch.

Another objective of the present invention is that said fuel distribution station for self-consumption is easily accessible to automotive vehicles.

Another objective of the present invention is to allow said fuel distribution station for self-consumption to be environmentally friendly.

Another objective of the present invention is to allow said fuel distribution station for self-consumption to easily integrate with additional components to form a fuel supply station of any desired size.

Another objective of the present invention is to allow said fuel distribution station for self-consumption to be designed to be easily transportable

Another objective of the invention is to allow said fuel distribution station for self-consumption to have a containment dam to avoid fuel spillage risks.

Another objective of the present invention is to allow said fuel distribution station for self-consumption not to require expensive civil works for its installation.

Another objective of the invention is to allow said fuel distribution station for self-consumption to be adapted to store different kinds of fuel among which gasoline, ethanol, and diesel can be found.

Another objective of the invention is to allow said fuel distribution station for self-consumption to have a storage capacity from 500 to 100,000 liters.

Another objective of the invention is to make available that said fuel distribution station for self-consumption allows ensuring the supply of fuel in the facilities of the users.

Another objective of the present invention is to allow said fuel distribution station for self-consumption to have at least one dispatch cabin that restricts access and secures the pumps for the supply of fuel.

Another objective of the present invention is to allow said fuel distribution station for self-consumption to be structurally designed to support the load therein.

Another objective of the invention is that said fuel distribution station for self-consumption that its cabin can be slightly loaded towards one of the two sides to better perform fuel dispatch.

Another objective of the invention is to allow said fuel distribution station for self-consumption to use any of the flow dispensing equipment, as well as manual or remote operating technologies by means of software for fuel dispatch.

Another objective of the invention is to allow said fuel distribution station for self-consumption to be very efficient in terms of energy consumption.

Another objective of the invention is that said fuel distribution station for self-consumption operating with voltages of 110 volts AC, 220 Volts AC, and 12 Volts CD depending on the installed equipment.

Another objective of the invention is that said fuel distribution station for self-consumption that has lifting lugs for transportation by means of which the maneuver of lifting the complete structure on a truck tract is performed.

Another objective of the present invention is to allow said fuel distribution station for self-consumption to be fully assembled on a load beater or reinforcement chassis.

Another objective of the present invention is to allow said fuel distribution station for self-consumption that uses a minimum number of pipes and wiring in its operation.

Another objective of the invention is that said fuel distribution station for self-consumption is that it can be easily manufactured, transported, and assembled.

And all those qualities and objectives that will become apparent when making a general and detailed description of the present invention supported by the illustrated modalities.

### BRIEF DESCRIPTION OF THE INVENTION

In general, the fuel distribution station for self-consumption, consists of a metal dam for spill containment consisting of a lower load frame consisting of 6-inch beams that serve as a reinforcing chassis that is the main part of load of all the structure, on which is mounted a steel plate floor and retaining walls perimeter-like and preferably with a 3/16 inch-thick-2½ inch angle in and 3.43 mm thick steel plate, reinforced with a structure of reinforcement that uses a 14-gauge, 2-inch rectangular profile.

Inside the containment walls of the metal dam for spill containment, a fuel storage tank is set horizontally, which has tank supports at the bottom and, on the upper side, has the following elements: service nozzles, cleaning nozzle or “male nozzle”, access ladder to upper floor of tank, lifting lugs and vent; the storage tank can be manufactured preferably with the following materials: carbon steel, stainless steel, aluminum, among others, of different thickness depending on the required capacity. The storage capacity of the storage tank can be from 500 to 100,000 liters.

In addition, it incorporates a dispatch cabin, also mounted on the lower frame, which includes a preferably rectangular design with the cabin at the center or slightly loaded towards one of the two sides to better perform the dispatch of the fuel; inside it has dispensing pumps for the supply of fuel, which are positioned in opposite directions so that the station can serve on both sides, the dispatch cabin is designed with one or two doors to safeguard the dispensing pump, includes curtains with mechanism of impulse and fittings for closing with padlock, said curtains with mechanism of impulse preferably are of 24 gauge galvanized sheet, the walls and ceiling of the dispatch cabin are preferably manufactured with 3.43 millimeter thick steel plate; the body structure of the dispatch booth is preferably made with a 14-gauge, 2-inch rectangular profile.

For the dispatch of fuel there is different equipment that can be used as Fill Rate pumps, medium or high flow dispensers; as well as manual dispensers or software for remote operation. The type of fuel can be selected from one of the following: gasoline, ethanol, and diesel.

For lifting and transportation, the fuel distribution station comprises fastening means preferably formed by lifting lugs, which are arranged on the four corners of the containment walls of the metal dam for containment of spills and on the upper floor of the fuel storage tank, said lifting lugs allow to perform the maneuver of lifting the fuel distribution station in its entirety and placing it on a platform to be transported by means of the use of a truck-tractor; the download is done in the same way. For placement on site, it is required that the land be compacted and leveled, so that it does not suffer deformations when filling the tank.

Said fuel distribution station for self-consumption, can operate with a power supply system of 110 volts AC, 220 Volts AC, and 12 Volts CD, depending on the installed equipment.

For its operation it also requires carbon steel pipes, fittings (elbows, nipples, reductions, nuts, unions, flexible hose), complete shut-off valves, filter holder and cartridge type filter (depending on the type of fuel it is the filter and the capacity filtering).

For product entry into the tank, it also requires carbon steel pipe, various accessories (elbows, nipples, reductions, nuts, unions, flexible hose), complete shut-off valves, check valves, connections for the fuel supply of the pipe, “Y” type filters; as well as level indicator type peephole of polycarbonate tube and valve set.

In order to better understand the characteristics of the invention, the present description is included as an integral part thereof, of the drawings which, with the more non-limiting illustrative character, are described below, corresponding to the preferred embodiment of the invention.

### BRIEF DESCRIPTION OF THE DRAWINGS

Drawing 1 shows a side view of the fuel distribution station for self-consumption.

Drawing 2 shows a plan view of the fuel distribution station for self-consumption.

Drawing 3 shows a perspective view of the fuel distribution station for self-consumption with the curtain of the closed dispatch cabin.

Drawing 4 shows another perspective view of the fuel distribution station for self-consumption with the curtain of the raised dispatch cabin.

For a better understanding of the invention, a detailed description will be made of some of the modalities thereof, shown in the drawings that are annexed to the present description for non-limiting illustrative purposes.

### DETAILED DESCRIPTION OF THE INVENTION

The characteristic details of the fuel distribution station for self-consumption are clearly shown in the following description and in the accompanying illustrative drawings, the same reference signs serving to indicate the same parts of the invention.

With reference to drawing 1, which presents a plan view of the fuel distribution station for self-consumption, where a metal dam 1 for spill containment, with access ladder 2 and containment walls 3 is shown; inside the containment walls 3 there is a fuel storage tank 4 which has nozzles for service 5, cleaning nozzle 6 or “male nozzle”, access ladder to upper floor 7, vent 8 and lifting lugs 9. A dispatch cabin 10, includes metal curtains 11 to restrict access to the interior thereof.

With reference to Drawing 2, which shows a side view of the fuel distribution station for self-consumption, where a metal dam 1 for containment of spills is shown formed by a lower load frame 12 serving as a reinforcement chassis, on which is mounted a floor 13 and retaining walls 3, reinforced with a reinforcing structure 14; inside the containment walls 3 there is a fuel storage tank 4, which at the bottom has supports for tank 15; at the same time we find lifting lugs 7 also in the four vertices of the metallic dam 1 for spill containment.

The dispatch cabin 13, is also mounted on the lower load frame 12, includes metal curtains 11 to safeguard inside the fuel dispensing pump (not shown).

With reference to drawing 3, which presents a perspective view of the fuel distribution station for self-consumption with the curtain of the dispatch cabin below, where a dispatch cabin 13 mounted also on the lower loading frame 12 is shown, which includes a preferably rectangular design with the dispatch cabin in the middle or slightly loaded towards one of the two sides of the dispatch, to better perform the dispatch of the fuel; the dispatch cabin is designed with one or two metal curtains 11 for safeguarding the dispensing pump (not shown), the metal curtains 11 include a pulse mechanism and fittings for lock 16 with padlock.

With reference to drawing 4, which presents a perspective view of the fuel distribution station for self-consumption with the curtain of the dispatch cabin above, where a dispensing pump 17 for the supply of fuel is shown inside, said pumps, the fuel dispensers 17 are positioned in opposite directions, so that the station can serve on both sides.

Said fuel distribution station for self-consumption, can operate with a power supply system of 110 volts AC, 220 Volts AC, and 12 Volts CD, depending on the installed equipment.

The invention has been thoroughly described so that a person with average skill in the field can reproduce and obtain the results that we mentioned in the present invention.

However, any person skilled in the field technique regarding the present invention may be able to make modifications not described in the present application, however, if for the application of these modifications in a certain structure or in the manufacturing process of the same, it is required of the matter claimed in the following clauses, said structures should be included within the invention scope.

Having thoroughly described the invention, the following clauses are claimed as property:

1. A fuel distribution station for self-consumption of the type of transportable stations that have a fuel storage tank connected to a fuel dispensing pump for motor vehicles, characterized in that it comprises a metal dam for spill containment formed by a lower load frame, on which is mounted a floor and reinforcing perimeter walls reinforced with a reinforcement structure; inside the containment walls of the metal dam there is a fuel storage tank, which has supports at the bottom and at least one of each element that is mentioned below: service nozzle, cleaning nozzle, staircase access, lifting and venting lugs; it also incorporates a fuel dispatch cabin, also mounted on the lower frame, which inside has at least one dispensing pump for the supply of fuel.

2. The fuel distribution station for self-consumption according to clause 1, characterized in that the dispatch cabin has at least one door and preferably two, useful to safeguard at least one dispensing pump, said at least one door includes curtain with mechanism of impulse and shut-off fittings with padlock; the dispatch cabin presents a preferably rectangular design with the cabin at the center or slightly loaded towards one of the two sides to perform better the dispatch of the fuel, inside it has dispensing pumps for the supply of fuel, which are positioned in opposite directions so that the station can serve on both sides.

3. The fuel distribution station for self-consumption according to claim 1, characterized in that it comprises fastening means formed by lifting lugs for lifting and transporting the fuel distribution station, which are arranged in the four vertices of the perimeter walls of containment of the metal dam for spill containment and on the upper floor of the fuel storage tank.

4. The fuel distribution station for self-consumption according to claim 1, characterized in that it can operate with a power supply system of 110 volts AC, 220 volts AC, and 12 volts CD, depending on the installed equipment.

5. The fuel distribution station for self-consumption according to claim 1, characterized in that the type of fuel supplied is selected from gasoline, ethanol, diesel, among others.

6. The fuel distribution station for self-consumption according to claim 1, characterized in that the storage capacity of the storage tank can be from 500 to 100,000 liters.

7. The fuel distribution station for self-consumption according to claim 1, characterized because it comprises pipes made of carbon steel or other similar material, elbows, nipples, reductions, fixing and joining means, flexible hose, full shut-off valves; check valves, filter holder and cartridge type filter, connections for the fuel supply of the pipe, “Y” type filters; as well as level indicator type peephole of polycarbonate tube and its set of valves.

8. The fuel distribution station for self-consumption according to claim 1, characterized in that the fuel dispenser is selected from Fill Rate pumps, medium or high flow dispensers; as well as manual dispensers or software for remote operation.
